(19) United States
(12) Patent Application Publication
(10) Pub. No.: US 2014/0295157 A1
(43) Pub. Date: Oct. 2, 2014

(54) WINDOW FOR DISPLAY DEVICE AND DISPLAY DEVICE INCLUDING THE WINDOW

(71) Applicant: Samsung Display Co., Ltd., Yongin-City (KR)

(72) Inventors: Akira HIRAI, Yongin-City (KR); Kwan-Young HAN, Yongin-City (KR); Hyoung-Suk ROH, Yongin-City (KR); Mikiya ITAKURA, Yongin-City (KR)

(21) Appl. No.: 14/224,760

(22) Filed: Mar. 25, 2014

(30) Foreign Application Priority Data
Mar. 26, 2013 (KR) 10-2013-0032292

(51) Int. Cl. B32B 27/08; B32B 27/28; B32B 7/02

(52) U.S. Cl. CPC B32B 27/08; B32B 7/02; B32B 27/283; B32B 2457/20; B32B 2307/30
USPC 428/215; 428/212

(57) ABSTRACT

A window for a display device includes a first resin layer including silsesquioxane, and a second resin layer disposed on one side of the first resin layer and including a polymer having a coefficient of thermal expansion of about ±20 ppm/° C. relative to the coefficient of thermal expansion of the silsesquioxane, and a display device including the same.

### CLAIM OF PRIORITY

This application makes reference to, incorporates into this specification the entire contents of, and claims all benefits accruing under 35 U.S.C. §119 from an application earlier filed in the Korean Intellectual Property Office on Mar. 26, 2013 and there duly assigned Serial No. 10-2013-0032292.

### BACKGROUND OF THE INVENTION

1. Field of the Invention

The present invention relates to a window for a display device and a display device including the same.

2. Description of the Related Art

Currently known display devices include a liquid crystal display (LCD), a plasma display panel (PDP), an organic light emitting diode (OLED) device, a field effect display (FED), an electrophoretic display device, and the like.

Such a display device includes a display module displaying an image and a window protecting the display module.

The window may be made of glass. However, since the glass may be easily broken by an external impact, a window made of the glass may be easily damaged when applied to a portable device such as a mobile phone. Therefore, a window made of a plastic material instead of glass has been recently researched.

Meanwhile, as a display device adopts a touch screen function, a hand or a sharp tool such as a pen may frequently contact one side of a window. In this case, the surface of the window made of plastic may be easily scratched. In addition, the window made of plastic may undergo appearance deformation such as curl or waving.

### SUMMARY OF THE INVENTION

One embodiment of the invention provides a window for a display device that prevents appearance deformation while ensuring surface hardness.

Another embodiment provides a display device including the window.

According to one embodiment, a window for a display device includes a first resin layer including silsesquioxane, and a second resin layer disposed on one side of the first resin layer and including a polymer having a coefficient of thermal expansion of about ±20 ppm/° C. relative to that of the silsesquioxane.

The silsesquioxane may have a coefficient of thermal expansion of about 60 to about 74 ppm/° C., and the polymer may have a coefficient of thermal expansion of about 48 to about 88 ppm/° C.

The polymer may include a polycarbonate (PC) resin, a polymethylmethacrylate (PMMA) resin, a cycloolefin polymer (COP) resin, a blend thereof, a copolymer thereof, or a combination thereof.

The first resin layer may have a thickness of about 10 μm to about 300 μm, and the second resin layer may have a thickness of about 10 μm to about 3 mm.

The window for a display device may further include an adhesion layer interposed between the first resin layer and the second resin layer.

The adhesion layer may have Young's modulus of less than or equal to about 1 MPa.

The second resin layer may be a λ/4 phase difference film.

The window for a display device may further include a third resin layer disposed on one side of the second resin layer and including a polymer having a coefficient of thermal expansion of about ±20 ppm/° C. relative to that of the silsesquioxane.

The polymer of the third resin layer may include a polycarbonate (PC) resin, a polymethylmethacrylate (PMMA) resin, a cycloolefin polymer (COP) resin, a blend thereof, a copolymer thereof, or a combination thereof.

The window for a display device may further include an adhesion layer interposed between the second resin layer and the third resin layer.

The adhesion layer may have Young's modulus of less than or equal to about 1 MPa.

The second resin layer and the third resin layer may be heat-bonded to each other.

The window for a display device may further include a fourth resin layer disposed on one side of the third resin layer and including a polymer different from that of the second resin layer or the third resin layer.

The first resin layer may be the uppermost layer of the window for a display device.

According to another embodiment, a display device including the window for a display device is provided.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a cross-sectional view showing a window for a display device according to one embodiment of the invention.

FIG. 2 is a cross-sectional view showing a window for a display device according to another embodiment of the invention.

FIG. 3 is a cross-sectional view showing a window for a display device according to yet another embodiment of the invention.

FIG. 4 is a cross-sectional view showing a window for a display device according to still another embodiment of the invention.

### DETAILED DESCRIPTION OF THE INVENTION

This disclosure will be described more fully hereinafter in the following detailed description, in which some but not all embodiments of this disclosure are described. This disclosure may be embodied in many different forms and should not be construed as limited to the embodiments set forth herein; rather, these embodiments are provided so that this disclosure will satisfy applicable legal requirements.

As used herein, when a description is not otherwise provided, one constituent element may be directly disposed on another constituent element, or a third constituent element may be further positioned on the constituent element.

In the drawings, the thicknesses of layers, films, panels, regions, etc. are exaggerated for clarity. Like reference numerals designate like elements throughout the specification. It will be understood that, when an element such as a layer, film, region, or substrate is referred to as being “on” another element, it can be directly on the other element or intervening elements may also be present. In contrast, when an element is referred to as being “directly on” another element, there is no intervening element present.

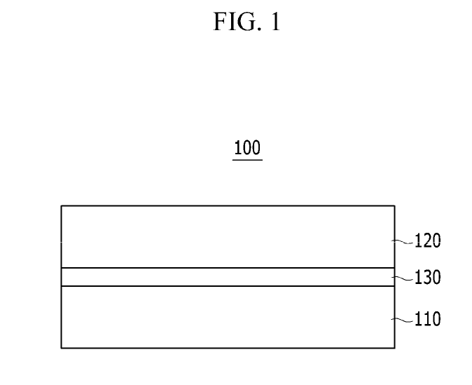

Referring to FIG. 1, a window for a display device according to one embodiment will be described.

FIG. 1 is a cross-sectional view showing a window for a display device according to one embodiment of the invention.

The window 100 for a display device according to one embodiment includes a first resin layer 120, a second resin layer 110 disposed on or adjacent to the first resin layer 120, and an adhesion layer 130 interposed between the first resin layer 120 and the second resin layer 110.

The first resin layer 120 includes silsesquioxane. The silsesquioxane has a bonding structure of a silicon atom (Si), a carbon atom (C), and an oxygen atom (O), and the bonding structure is classified into a cage-type, a ladder-type, a random-type, or a combination thereof.

The silsesquioxane may have high light transmittance and a high hardness, for example, of greater than or equal to about 6H, and specifically ranging from about 6H to about 9H. Accordingly, the first resin layer 120 including silsesquioxane may be the uppermost layer of a window for a display device and may secure surface hardness of the window. Herein, the first resin layer 120 is the uppermost layer of a window for a display device, and thus directly has an influence on surface hardness of the window, which does not exclude the possibility of forming thereon an additional layer applying an additional function, for example, an antireflective film.

The first resin layer 120 may have a thickness of about 10 μm to about 300 μm. When the first resin layer 120 has a thickness within the range, appropriate strength and flexibility thickness may be secured.

The second resin layer 110 may be a transparent substrate and is positioned on one side of the first resin layer 120, and thus it may secure mechanical strength of the window 100 for a display device.

The second resin layer 110 may include a polymer having a coefficient of thermal expansion of about ±20 ppm/° C. relative to the coefficient of thermal expansion of the silsesquioxane in the first resin layer 120. For example, when the silsesquioxane have a coefficient of thermal expansion of about 60 to about 74 ppm/° C., the polymer may have a coefficient of thermal expansion of about 48 to about 88 ppm/° C.

The polymer having a coefficient of thermal expansion within the above range may be, for example, a polycarbonate (PC) resin, a polymethylmethacrylate (PMMA) resin, a cycloolefin polymer (COP) resin, a blend thereof, a copolymer thereof, or a combination thereof.

In this way, the window may be prevented from curl or waving due to a temperature change during cooling down to room temperature during and after curing silsesquioxane by forming the second resin layer 110, including the polymer having a coefficient of thermal expansion within a predetermined range relative to the coefficient of thermal expansion of the silsesquioxane, on one side of the first resin layer 120 including silsesquioxane.

In addition, since the first resin layer 120 including silsesquioxane does not need to be symmetrically formed on both sides of the second resin layer 110 in order to prevent the curl and waving, easy destruction of the first resin layer 120 including silsesquioxane by a tensile stress on the other side applied from an impact on one side thereof may be prevented when the first resin layer 120 including silsesquioxane is symmetrically formed on both sides of the second resin layer 110.

Accordingly, the second resin layer 110, including a polymer having a coefficient of thermal expansion within a predetermined range relative to the coefficient of thermal expansion of silsesquioxane, may be formed on one side of the first resin layer 120 including silsesquioxane to prevent appearance deformation and improve impact resistance as well as secure high surface hardness.

The second resin layer 110 may be a compensation film, for example a λ/4 phase difference film. When the second resin layer 110 is used as a compensation film, the wavelength dispersion characteristic of the second resin layer 110 may be, for example, adjusted by elongating the film including the polymer, elongating the film after adding an optically anisotropic material, or stacking plural layers.

In addition, when the second resin layer 110 is used as a compensation film, the second resin layer 110 may effectively cut off externally incident light from the front side of a display device, and thus prevent reflection of the light. Accordingly, visibility of a display device may be improved.

The second resin layer 110 may have a thickness of about 10 μm to about 3 mm.

The adhesion layer 130 may include a transparent adhesive bonding with the first resin layer 120 and the second resin layer 110. The transparent adhesive may include, for example, a thermoplastic adhesive, a photocurable adhesive, a thermally curable adhesive, and the like but is not limited thereto.

The adhesion layer 130 may be a high elasticity layer having Young's modulus of less than or equal to about 1 MPa and specifically, about 0.01 to about 0.1 MPa within the range. As described above, the adhesion layer 130 having high elasticity may improve impact resistance.

The adhesion layer 130 may have a thickness of about 3 μm to about 200 μm.

The window 100 for a display device may further include a functional film, such as an antireflective film, on the first resin layer 120.

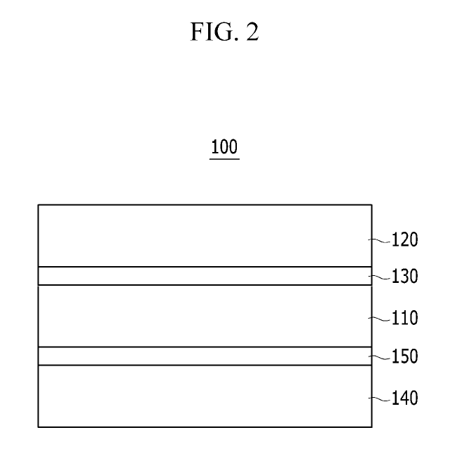

Referring to FIG. 2, a window for a display device according to another embodiment will be described.

FIG. 2 is a cross-sectional view showing a window for a display device according to another embodiment of the invention.

Referring to FIG. 2, the window 100 for a display device according to the present embodiment includes a first resin layer 120 including silsesquioxane, a second resin layer 110 disposed on one side of the first resin layer 120 and including a polymer having a coefficient of thermal expansion of about ±20 ppm/° C. relative to the coefficient of thermal expansion of the silsesquioxane, and an adhesion layer 130 interposed between the first resin layer 120 and the second resin layer 110 as in the previous embodiment.

However, the window 100 for a display device according to this embodiment further includes a third resin layer 140 on one side of the second resin layer 110 and an adhesive 150 between the second resin layer 110 and the third resin layer 140 unlike in the aforementioned embodiment.

The third resin layer 140 may include the polymer having a coefficient of thermal expansion of about ±20 ppm/° C. relative to that of the silsesquioxane as in the second resin layer 110. Such a polymer may include, for example, a polycarbonate (PC) resin, a polymethylmethacrylate (PMMA) resin, a cycloolefin polymer (COP) resin, a blend thereof, a copolymer thereof, or a combination thereof.

The second resin layer 110 and the third resin layer 140 may include the same polymer or a different polymer from each other.

When the third resin layer 140 is further added, the second resin layer 110 and the third resin layer 140 may be appropriately adjusted with respect to material quality, thickness, and the like, and accordingly, curl or waving of the window depending on a temperature change may be minutely regulated.

The adhesion layer 150 may include a transparent adhesive bonding the second resin layer 110 and the third resin layer 140, and the transparent adhesive is the same as aforementioned. The adhesion layer 150 may be a highly elastic layer having Young's modulus of less than or equal to about 1 MPa, like the adhesion layer 130, and specifically, about 0.01 to 0.1 MPa within the range.

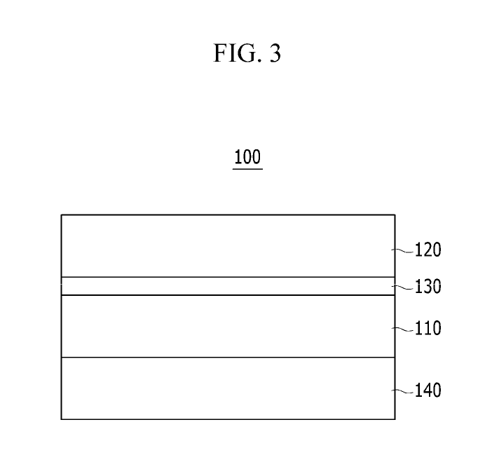

Referring to FIG. 3, a window for a display device according to yet another embodiment will be described.

FIG. 3 is a cross-sectional view showing the window for a display device according to yet another embodiment of the invention.

Referring to FIG. 3, the window 100 for a display device according to the present embodiment includes a first resin layer 120 including silsesquioxane, a second resin layer 110 disposed on one side of the first resin layer 120 and including a polymer having a coefficient of thermal expansion of about ±20 ppm/° C. relative to the coefficient of thermal expansion of the silsesquioxane, an adhesion layer 130 interposed between the first resin layer 120 and the second resin layer 110, and a third resin layer 140 disposed on one side of the second resin layer 110 and including a polymer having a coefficient of thermal expansion of about ±20 ppm/° C. relative to that of the silsesquioxane, as in the above embodiment.

However, the window 100 for a display device according to this embodiment includes the second resin layer 110 and the third resin layer 140 not bonded by an adhesion layer but heat-bonded unlike in the aforementioned embodiment.

When the second resin layer 110 and the third resin layer 140 are heat-bonded, adhesion intensity between the second resin layer 110 and the third resin layer 140 may be increased.

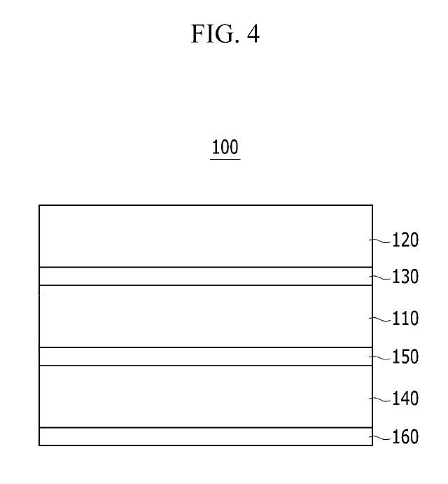

Referring to FIG. 4, a window for a display device according to still another embodiment will be described.

FIG. 4 is a cross-sectional view showing a window for a display device according to still another embodiment of the invention.

Referring to FIG. 4, the window 100 for a display device according to this embodiment includes a first resin layer 120 including silsesquioxane, a second resin layer 110 disposed on one side of the first resin layer 120 and including a polymer having a coefficient of thermal expansion of about ±20 ppm/° C. relative to that of the silsesquioxane, an adhesion layer 130 interposed between the first resin layer 120 and the second resin layer 110, a third resin layer 140 disposed on one side of the second resin layer 110 and including a polymer having a coefficient of thermal expansion of about ±20 ppm/° C. relative to that of the silsesquioxane, and an adhesion layer 150 interposed between the second resin layer 110 and the third resin layer 140.

However, the window 100 for a display device according to this embodiment further includes a fourth resin layer 160 on one side of the third resin layer 140, unlike in the aforementioned embodiment.

The fourth resin layer 160 may include the same polymer having a coefficient of thermal expansion of about ±20 ppm/° C. relative to that of the silsesquioxane as in the second resin layer 110 or the third resin layer 140, but may include a polymer different from those in the second resin layer 110 or the third resin layer 140.

When the fourth resin layer 160 is further included, the second resin layer 110, the third resin layer 140, and the fourth resin layer 160 may be appropriately adjusted as to material quality, thickness, and the like, and accordingly, curl or waving of the window depending on a temperature change may be minutely regulated.

The adhesion layer 150 may be omitted if necessary, and the second resin layer 110 and the third resin layer 140 may be heat-bonded as in the aforementioned embodiment.

The above described window for a display device may be applied for various display devices. The display device may be a liquid crystal display (LCD), an organic light emitting diode (OLED) device, a plasma display, a field effect display device, an electrophoresis display device, and the like, but is not limited thereto.

The window for a display device may be disposed on a display module, wherein the display module may be a liquid crystal display module, an organic light emitting display module, a plasma display module, an electric field effect display module, an electrophoresis display module, and the like.

Hereinafter, the present disclosure is illustrated in more detail with reference to examples. However, these embodiments are exemplary, and the present disclosure is not limited thereto.

### EXAMPLES 1-21/COMPARATIVE EXAMPLES 1-2

A window for a display device was manufactured by sequentially laminating a first resin layer formed of silsesquioxane (Silplus, NSCC, CTE=68 ppm/° C.), an adhesion layer including an acryl-based transparent adhesive (NITTO DENKO CS-9620T, Japan), and a second resin layer formed of the following polymer as provided in Table 1.

TABLE 1

| | | Acryl-based | | | | | |
|---|---|---|---|---|---|---|---|
| | | transparent | | | | | |
| | First | adhesive | | | | | |
| | resin | Elastic | | Second resin layer | | | |
| | layer | coeffi- | Thick- | | | Thick- | |
| | (Silplus) | cient | ness | Kind of | Tg | ness | |
| No. | (μm) | (MPa) | (μm) | polymer | (° C.) | (μm) | CTE |
| Ex. 1 | 100 | 0.1 | 10 | PMMA | 107 | 10 | 70 |
| Ex. 2 | 100 | 0.1 | 10 | | | 50 | |
| Ex. 3 | 100 | 0.1 | 10 | | | 100 | |
| Ex. 4 | 100 | 0.1 | 10 | | | 500 | |
| Ex. 5 | 100 | 0.1 | 10 | | | 1000 | |
| Ex. 6 | 10 | 0.1 | 10 | | | 100 | |
| Ex. 7 | 50 | 0.1 | 10 | | | 100 | |
| Ex. 8 | 200 | 0.1 | 10 | | | 100 | |
| Ex. 9 | 100 | 0.1 | — | PC | 145 | — | 68 |
| Ex. 10 | 100 | 1,000 | 10 | | | 500 | |
| Ex. 11 | 100 | 1,000 | 50 | | | 500 | |
| Ex. 12 | 100 | 1,000 | 100 | | | 500 | |
| Ex. 13 | 100 | 1,000 | 100 | | | 100 | |
| Ex. 14 | 100 | 0.1 | 10 | Plastic | | 500 | 48/88 |
| Ex. 15 | 100 | 0.1 | 10 | | | 500 | 58/78 |
| Ex. 16 | 100 | 0.1 | 10 | | | 1,000 | 48/88 |
| Ex. 17 | 100 | 0.1 | 10 | | | 2,000 | 48/88 |
| Ex. 18 | 100 | 0.1 | 10 | | | 3,000 | 48/88 |
| Comp. | 100 | 0.1 | 10 | PET | 120 | 50 | 20 |
| Ex. 1 | | | | | | | |
| Comp. | 100 | 0.1 | 10 | | | 150 | |
| Ex. 2 | | | | | | | |

* plastic may be a polymer having CTE(68 ppm/° C.) of a first resin layer (silplus) ±10 ppm/° C. or ±20 ppm/° C.

### Evaluation 1

The windows for a display device according to Examples 1 to 18 and Comparative Examples 1 and 2 were evaluated regarding a curl when a temperature was increased from room temperature 25° C. to 85° C. The curl was evaluating by marking a concave curl as a minus (−) and a convex curl as a plus (+) with reference to a flat part.

The results provided in Table 2.

TABLE 2

| | Curl (mm) |
|---|---|
| Example 1 | −1.3 |
| Example 2 | −2.1 |
| Example 3 | −1.7 |
| Example 4 | −0.3 |
| Example 5 | −0.1 |
| Example 6 | −0.9 |
| Example 7 | −1.9 |
| Example 8 | −1.1 |
| Example 9 | 0 |
| Example 10 | −0.1 |
| Example 11 | −0.4 |
| Example 12 | −0.7 |
| Example 13 | +0.03 |
| Example 14 | +3.2/−3.2 |
| Example 15 | +1.6/−1.6 |
| Example 16 | +1.1/−1.1 |
| Example 17 | +0.3/−0.3 |
| Example 18 | +0.14/−0.14 |
| Comparative Example 1 | +51.0 |
| Comparative Example 2 | +29.0 |

Referring to Table 2, the windows for a display device according to Examples 1 to 18 had a remarkably small curl compared with those of Comparative Examples 1 and 2. Accordingly, when a polymer having a coefficient of thermal expansion within a predetermined range relative to the coefficient of thermal expansion of silsesquioxane is used, appearance deformation of a window, such as curling, was remarkably decreased.

### EXAMPLES 22-28

As shown in Table 3, windows for a display device were manufactured by sequentially laminating a first resin layer made of silsesquioxane (Silplus, NSCC, CTE=68 ppm/° C.), an adhesion layer including an acryl-based transparent adhesive, a second resin layer made of a first polymer, an adhesion layer including an acryl-based transparent adhesive, a third resin layer made of a second polymer, and optionally, a fourth resin layer made of a third polymer.

TABLE 3

| | | | | Second resin | | | | Third resin | | Fourth resin | |
|---|---|---|---|---|---|---|---|---|---|---|---|
| | First resin | Adhesive | | layer | | Adhesive | | layer | | layer | |
| | layer | | Thick- | | Thick- | | thick- | | Thick- | | Thick- |
| | (Silplus) | | ness | Kind of | ness | | ness | Kind of | ness | Kind of | ness |
| No. | (μm) | E | (μm) | polymer | (μm) | E | (μm) | polymer | (μm) | polymer | (μm) |
| Ex. 19 | 100 | 100 | 50 | PMMA | 100 | — | — | — | — | — | — |
| Ex. 20 | 100 | 100 | 50 | | | 100 | 10 | PC | 400 | — | — |
| Ex. 21 | 100 | 100 | 50 | | | 100 | 10 | PMMA | 400 | — | — |
| Ex. 22 | 100 | 100 | 50 | | | 100 | 10 | PMMA | 400 | PC | 100 |
| Ex. 23 | 100 | 100 | 50 | PC | 125 | 100 | 10 | PMMA | 400 | — | — |
| Ex. 24 | 100 | 100 | 50 | | | 100 | 10 | PMMA | 400 | PC | 100 |
| Ex. 25 | 100 | 100 | 50 | | | 100 | 10 | PMMA | 500 | PC | 100 |

### Evaluation 2

The windows for a display device according to Examples 19 to 25 were evaluated regarding a curl when a temperature was increased from room temperature 25° C. to 85° C. The curl was evaluated by marking a concave curl as a minus (−) and a convex curl as a plus (+) with reference to a flat part.

The results are provided in Table 4.

TABLE 4

| | Curl (mm) |
|---|---|
| Example 19 | −1.4 |
| Example 20 | +0.15 |
| Example 21 | −0.3 |
| Example 22 | −0.07 |
| Example 23 | −0.51 |
| Example 24 | −0.24 |
| Example 25 | −0.20 |

Referring to Table 4, the windows for a display device according to Examples 19 to 25 had appearance deformation to a satisfactory degree. In addition, the appearance deformation was subtly regulated by additionally forming the third resin layer and optionally the fourth resin layer, and adjusting the kind and thickness of the third and fourth resin layers.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A window for a display device, comprising:
a first resin layer including silsesquioxane; and
a second resin layer disposed on one side of the first resin layer and comprising a polymer having a coefficient of thermal expansion of about ±20 ppm/° C. relative to the coefficient of thermal expansion of the silsesquioxane.

2. The window for a display device of claim 1, wherein the silsesquioxane has a coefficient of thermal expansion of about 60 to about 74 ppm/° C., and the polymer has a coefficient of thermal expansion of about 48 to about 88 ppm/° C.

3. The window for a display device of claim 1, wherein the polymer comprises one of a polycarbonate (PC) resin, a polymethylmethacrylate (PMMA) resin, a cycloolefin polymer (COP) resin, a blend thereof, a copolymer thereof, and a combination thereof.

4. The window for a display device of claim 1, wherein the first resin layer has a thickness of about 10 μm to about 300 μm, and the second resin layer has a thickness of about 10 μm to about 3 mm.

5. The window for a display device of claim 1, further comprising an adhesion layer interposed between the first resin layer and the second resin layer.

6. The window for a display device of claim 5, wherein the adhesion layer has a Young's modulus not greater than about 1 MPa.

7. The window for a display device of claim 1, wherein the second resin layer is a λ/4 phase difference film.

8. The window for a display device of claim 1, further comprising a third resin layer disposed on one side of the second resin layer and including a polymer having a coefficient of thermal expansion of about ±20 ppm/° C. relative to the coefficient of thermal expansion of the silsesquioxane.

9. The window for a display device of claim 8, wherein the polymer of the third resin layer comprises one of a polycarbonate (PC) resin, a polymethylmethacrylate (PMMA) resin, a cycloolefin polymer (COP) resin, a blend thereof, a copolymer thereof and a combination thereof.

10. The window for a display device of claim 8, further comprising an adhesion layer interposed between the second resin layer and the third resin layer.

11. The window for a display device of claim 10, wherein the adhesion layer has a Young's modulus not greater than about 1 MPa.

12. The window for a display device of claim 8, wherein the second resin layer and the third resin layer are heat-bonded to each other.

13. The window for a display device of claim 8, further comprising a fourth resin layer disposed on one side of the third resin layer and including a polymer different from at least one of the second resin layer and the third resin layer.

14. The window for a display device of claim 1, wherein the first resin layer is the uppermost layer of the window for a display device.

15. A display device comprising the window for a display device according to claim 1.
